(19) United States
(12) Patent Application Publication
(10) Pub. No.: US 2018/0043292 A1
(43) Pub. Date: Feb. 15, 2018

(54) SWIRL TUBE SEPARATORS

(71) Applicant: SHELL OIL COMPANY, Houston, TX (US)

(72) Inventor: Cian Seamus CARROLL, Katy, TX (US)

(21) Appl. No.: 15/555,816

(22) PCT Filed: Mar. 1, 2016
(86) PCT No.: PCT/US2016/020254

§ 371 Date: Sep. 5, 2017

Related U.S. Application Data
(60) Provisional application No. 62/127,631, filed on Mar. 3, 2015.

(51) Int. Cl. B01D 45/16; B04C 5/107; B04C 5/181; B04C 5/06

(52) U.S. Cl. CPC B01D 45/16; B04C 5/06; B04C 5/107; B04C 5/181

(57) ABSTRACT

A separation swirl tube comprising: a tubular housing, a gas-solids inlet opening, a gas outlet conduit, a vane, and a VSP vortex stabilizer and associated methods and systems.

### CROSS REFERENCE TO RELATED APPLICATIONS

This application claims the benefit of U.S. Provisional Application No. 62/127,631, filed Mar. 3, 2015, which is incorporated herein by reference.

### BACKGROUND

The present disclosure generally relates to improved swirl tube separators. More specifically, in certain embodiments the present disclosure relates to improved swirl tube separators comprising VSP vortex stabilizers and associated methods and systems.

The removal of finely-divided solid particles from entraining gases is necessary in almost any system in which the gas is to be passed through a fluid dynamic device containing gas-deflecting walls, such as an expansion turbine at an expander, to prevent erosion damage to such systems. Additionally, if the entraining gas is ultimately to be discharged to the atmosphere, the removal of particulate matter is also important from an environmental conservation standpoint. Emission levels of below 50 mg/Nm³ are sometimes required because of these environmental restrictions.

Examples of suitable separators for removal of finely divided solid particles from entraining gases are third stage separators, some of which are described in Hydrocarbon Processing, January 1985, 51-54. Third stage separators remove, to an acceptable level, the fine particles still present in gas streams leaving fluid catalyzed cracker regenerators just up-stream of an expander turbine or flue-gas boiler. It has been found that third stage separators may also find uses in other processes, wherein finely divided solid particles are to be separated from entraining gases. Examples of such processes are direct iron reduction processes, coal gasification processes, coal based power plants, and calcining processes, such as aluminium calcining.

Third stage separators may comprise a plurality of parallel-arranged swirl tube separators. Examples of swirl tube separators are described in EP-B-360360, U.S. Pat. No. 4,863,500, U.S. Pat. No. 4,810,264, U.S. Pat. No. 5,681,450, GB-A-1411136 and U.S. Pat. No. 3,541,766, the entireties of which are hereby incorporated by reference. Briefly, these third stage separators perform separation by the creation of a cyclone within each swirl tube separator and utilize the cyclone for physical separation by utilizing the various inertial differences between the species present in the swirl tube.

Several of these swirl tube separators described above may comprise a vortex stabilizer. It is believed that the vortex stabilizer can increase the separation efficiency of the third stage separator by keeping the vortexes formed in the center of each of the swirl tube separators. One particular vortex stabilizer is described in U.S. Pat. No. 7,648,544, the entirety of which is hereby incorporated by reference. Briefly, U.S. Pat. No. 7,648,544 describes a swirl tube separator design that includes the presence of a vortex extender pin (a long thin rod commonly referred to as an S-Pin) that is designed to hold the swirl tube vortex in the center of the swirl tube separator.

However, the use of an S-Pin in a swirl tube separator may be problematic. In certain instances, the S-pin may suffer from metal fatigue at several locations and may eventually fall out of the swirl tubes. This may result in a reduction of the third stage separator performance and may require significant amount of downtime to fix. Furthermore, these swirl tube separators may not be able to operate at 100% efficiency for certain particles and may suffer from particle transfer between individual swirl tubes, which is commonly referred to a “cross talk.”

It is desirable to develop a new separation swirl tube design that does not suffer from the problems of the current separation swirl tube designs and yet is able to still perform at the same level or above.

### SUMMARY

The present disclosure generally relates to improved swirl tube separators. More specifically, in certain embodiments the present disclosure relates to improved swirl tube separators comprising VSP vortex stabilizers and associated methods and systems.

In one embodiment, the present disclosure provides a separation swirl tube comprising: a tubular housing, a gas-solids inlet opening, a gas outlet conduit, a vane, and VSP vortex stabilizer.

In another embodiment, the present disclosure provides a third stage separator comprising: a pressure vessel, a flue gas/catalyst fine inlet, a flue gas outlet, an underflow gas/catalyst fine outlet, and a swirl tube separator, wherein the swirl tube separator comprises a tubular housing, a gas-solids inlet opening, a gas outlet conduit, a vane, and VSP vortex stabilizer.

In another embodiment, the present disclosure provides a method comprising: providing a third stage separator, wherein the third stage separator comprises a pressure vessel, a flue gas/catalyst fine inlet, a flue gas outlet, an underflow gas/catalyst fine outlet, and a swirl tube separator, wherein the swirl tube separator comprises a tubular housing, a gas-solids inlet opening, a gas outlet conduit, a vane, and VSP vortex stabilizer; and introducing a flue gas and catalyst mixture into the third stage separator.

### BRIEF DESCRIPTION OF THE DRAWINGS

A more complete and thorough understanding of the present embodiments and advantages thereof may be acquired by referring to the following description taken in conjunction with the accompanying drawings.

FIG. 1 illustrates a cross sectional view of a swirl tube separator in accordance with certain embodiments of the present disclosure.

FIG. 2 illustrates a cross section view of a VSP vortex stabilizer in accordance with certain embodiments of the present disclosure.

FIG. 3 illustrates a cross sectional view of a third stage separator, in accordance with certain embodiments of the present disclosure.

FIG. 4 is a graph illustrating the efficiency of various swirl tube separator systems.

FIG. 5 illustrates the cross talk of various swirl tube separator systems.

FIG. 6 illustrates the particle vectors of particles in various swirl tube separator systems.

The features and advantages of the present disclosure will be readily apparent to those skilled in the art. While numerous changes may be made by those skilled in the art, such changes are within the spirit of the disclosure.

### DETAILED DESCRIPTION

The description that follows includes exemplary apparatuses, methods, techniques, and/or instruction sequences that embody techniques of the inventive subject matter. However, it is understood that the described embodiments may be practiced without these specific details.

The present disclosure generally relates to improved swirl tube separators. More specifically, in certain embodiments the present disclosure relates to improved swirl tube separators comprising VSP vortex stabilizers and associated methods and systems.

It has recently been believed that the inner vortex within the swirl tube could be terminated using S-pin devices and that this was sufficient to prevent entrainment of solids into the vortex flow. However, it has been found that terminating the vortex may not always prevent solids entrainment from underneath the S-pin device. It was also believed that utilizing a solid boundary to prevent underflow entrainment would result in high swirl tube pressure drop since the outlet area of the swirl tube would be partially obstructed.

The improved swirl tube separators described herein have several advantages. First, in certain embodiments, the swirl tube separators described herein do not comprise an S-Pin and thus do not experience downtime due to S-Pin failure. Second, the swirl tube separators described herein have a higher efficiency than conventional swirl tube separators. Third, the swirl tube separators described herein do not suffer from the cross talk phenomena as they experience less particulate back flow due to having no vortex recirculation zone at the base of the outlet tube and thus can be sized shorter and/or smaller than conventional swirl tube separators. Fourth, in certain embodiments when desired, the swirl tube separators described herein may comprise an S-Pin.

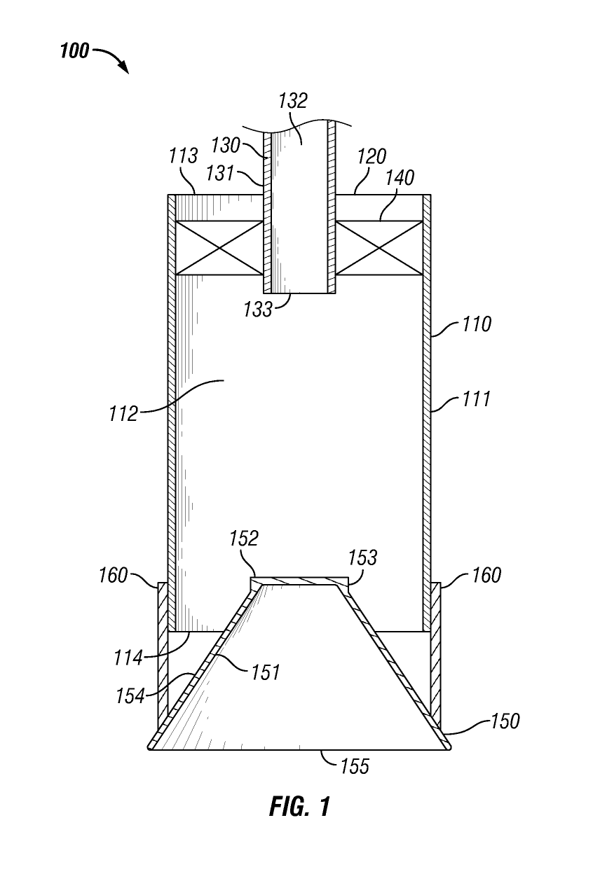

Referring now to FIG. 1, FIG. 1 illustrates swirl tube separator 100 in accordance with certain embodiments of the present disclosure. In certain embodiments, swirl tube separator 100 may comprise the basic features of conventional swirl tube separators. Examples of conventional swirl tubes separators are described in U.S. Pat. Nos. 3,541,766, 5,690,709, 5,328,592, 5,372,707, 5,514,271, and 6,174,339, the entireties of which are hereby incorporated by reference.

In certain embodiments, swirl tube separator 100 may be a reverse flow swirl tube separator. As can be seen in FIG. 1, in certain embodiments swirl tube separator 100 may comprise tubular housing 110, gas-solids inlet 120, a gas outlet conduit 130, vane 140, and vortex stabilizer 150.

In certain embodiments, tubular housing 110 may comprise any conventional tubular housing used in conventional swirl tube separators. In certain embodiments, tubular housing 110 may be constructed of metals, metal alloys, and/or ceramics and may be lined with erosion resistant coatings or ceramic lining. In certain embodiments, tubular housing 110 may have a cylindrical shape with an inner diameter and an inner length. In certain embodiments, tubular housing 110 may comprise tubular wall 111 defining hollow interior 112, top opening 113, and bottom opening 114.

In certain embodiments, tubular housing 110 may have an inner diameter in the range of from 0.15 to 1.5 meters. In other embodiments, tubular housing 110 may have an inner diameter in the range of from 0.15 to 3 meters. In other embodiments, tubular housing 110 may have an inner diameter of from 0.5 to 2 meters.

In certain embodiments, the inner diameter of tubular housing 110 may be uniform across tubular housing 110. In certain embodiments, the inner diameter of tubular housing 110 may be non-uniform across tubular housing 110. In certain embodiments, tubular housing 110 may comprise a taper with a larger inner diameter and/or a smaller inner diameter at top opening 113 and/or bottom opening 114.

In certain embodiments, tubular hosing 110 may have an inner length in the range of from 0.1 to 15 meters. In other embodiments, tubular housing 110 may have an inner length in the range of from about 0.5 meters to 10 meters. In other embodiments, tubular housing 110 may have an inner length in the range of from 0.5 meter to 1.5 meters.

In certain embodiments, tubular housing 110 may have an inner length to inner diameter ratio of from 1.5:1 to 25:1. In other embodiments, tubular housing 110 may have an inner length to inner diameter ratio of from 2:1 to 10:1. In other embodiments, tubular housing 110 may have an inner length to inner diameter ratio of from 2.5:1 to 5:1.

In certain embodiments, the inner diameter of top opening 113 and/or bottom opening 114 may be the same as the inner diameter of tubular housing 110. In other embodiments, the inner diameter of top opening and/or bottom opening 114 may vary in the range from 0.05 meters to 0.5 meters.

In certain embodiments, gas-solids inlet 120 may be positioned at top opening 113. In certain embodiments, gas-solids inlet 120 may comprise the annulus formed by tubular wall 111 and gas outlet conduit wall 131 of gas outlet conduit 130.

In certain embodiments, gas-solids inlet 120 may permit the flow of gas and solids into swirl tube 100. In certain embodiments, bottom opening 114 may permit the flow of solids out of swirl tube 100 and the flow of gas into swirl tube 100. In certain embodiments, gas-solids inlet 120 and bottom opening 114 may be sized to allow the flow of gas into swirl tube 100 at gas flow rates in the range of from 10 ACFM to 40 ACFM. In certain embodiments, gas-solids inlet 120 and bottom opening 114 may be sized to allow the flow of solids into swirl tube 100 at flow rates in the range of from 5 mg/Nm3 to 1500 mg/Nm3. In certain embodiments, swirl tube 100 may be operated at temperatures in the range of from 25° C. to 850° C. and pressures in the range of from 0 barg to 5 barg or more.

In certain embodiments, gas outlet conduit 130 may comprise a gas outlet conduit wall 131 defining hollow interior 132 and bottom opening 133.

In certain embodiments, gas outlet conduit 130 may have an inner diameter in the range of from 0.045 meters to 0.9 meters. In other embodiments, gas outlet conduit 130 may have an inner diameter in the range of from 0.1 meters to 1 meter. In other embodiments, gas outlet conduit 130 may have an inner diameter in the range of from 0.1 meters to 0.5 meters. In other embodiments, gas outlet conduit 130 may have an inner diameter in the range of from 0.1 meters to 0.25 meters.

In certain embodiments, the ratio of the inner diameter of gas outlet conduit 130 to the inner diameter of tubular housing 110 may be in the range of from 0.1:1 to 0.6:1. In other embodiments, the ratio of the inner diameter of gas outlet conduit 130 to the inner diameter of tubular housing 110 may be in the range of from 0.3:1 to 0.5:1.

In certain embodiments, a portion of gas outlet conduit 130 may extend into hollow interior 112 of tubular housing 110 through top opening 113. In certain embodiments, gas outlet conduit 130 may extend a distance in the range of from 0.1 meters to 0.5 meters into hollow interior 112. In other embodiments, gas outlet conduit 130 may extend a distance in the range of from 0.2 meters to 0.4 meters into hollow interior 112.

In certain embodiments, bottom opening 133 of gas outlet conduit 130 may have the same inner diameter of gas outlet conduit 130. In other embodiments, bottom opening 133 of gas outlet conduit 130 may have a larger inner diameter than gas outlet conduit 130.

In certain embodiments, gas outlet conduit 130 may permit the exit of gas out of swirl tube separator 100. In certain embodiments, gas outlet conduit 130 may be sized to permit the flow of gas out of swirl tube separator 100 at a flow rate in the range of from 10 AFCM to 100 AFCM. In certain embodiments, gas outlet conduit 130 may be attached to a gas plenum (not illustrated in FIG. 1).

In certain embodiments, vane 140 may comprise one or more angle turning vanes that are capable of directing flow in a swirling motion. In certain embodiments, vane 140 may be constructed from metals, metal alloys, and/or ceramics and may be coated with ceramic or a wear resistant coating. In certain embodiments, vane 140 may have a diameter in the range of from 0.1 meters to 0.5 meters. In certain embodiments, vane 140 may be sized to fit in an annulus defined by tubular wall 111 and gas outlet conduit wall 131.

In certain embodiments, vane 140 may be positioned within an annulus defined by tubular wall 111 and gas outlet conduit wall 131. In certain embodiments, vane 140 may be positioned a distance below inlet 130 in the range of from 0 meters to 0.4 meters.

In certain embodiments, vane 140 may allow for the formation of a cyclone within hollow interior chamber 112 as gas-solids gas is introduced into hollow interior chamber 112. In certain embodiments, the vortex may be generated by swirling flow at the exiting vane 140. The swirling flow, along with gas outlet 130, may generate a low pressure cyclone within hollow interior chamber 112. In certain embodiments, the formation of a cyclone may allow for the separation of gas and solids and allowing for gas to exit through gas outlet conduit 130. In certain embodiments, the centrifugal forces exerted by the rotational flow may separate the solids from the gases within the cyclone as the inertial forces move the solids to the swirl tube wall. Gas may then be removed from hollow interior chamber 112 via the gas outlet tube 130 while the solids may exit through bottom opening 114.

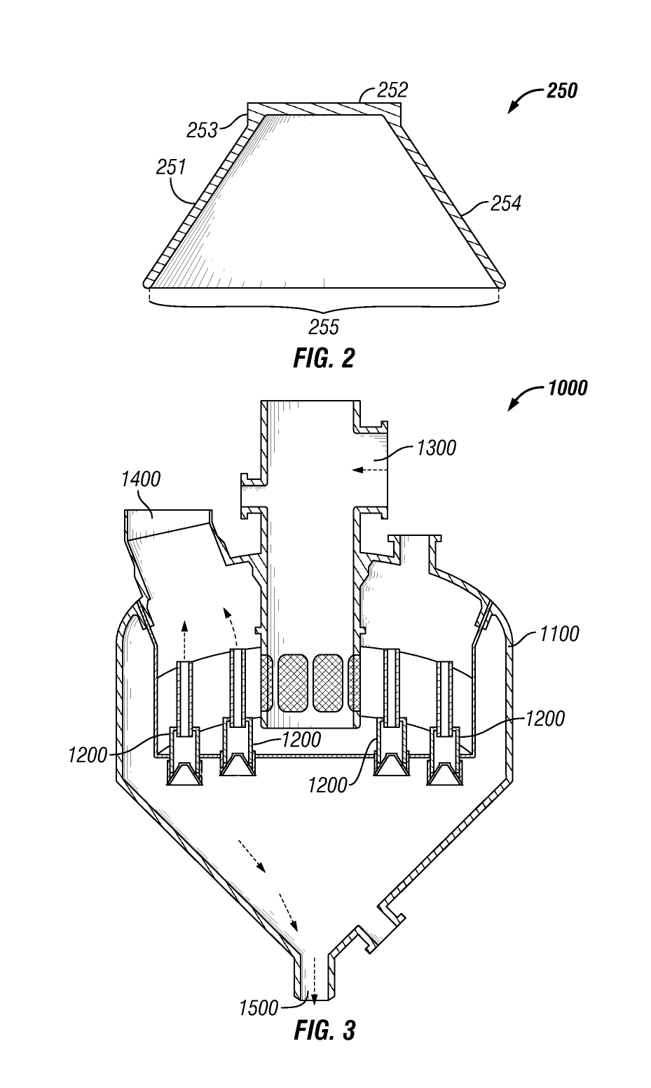

In certain embodiments, vortex stabilizer 150 may comprise a VSP vortex stabilizer. As used herein, the term VSP vortex stabilizer is defined as any vortex stabilizer comprising a frustum or conical base. In certain embodiments, the VSP vortex stabilizer may comprise a cylindrical top portion on top of the frustum base. FIG. 2 illustrates VSP vortex stabilizer in accordance with certain embodiments of the present disclosure.

Referring now to FIG. 2, FIG. 2 illustrates VSP vortex stabilizer 250. In certain embodiments, not illustrated in FIG. 2, VSP vortex stabilizer 250 may be a solid structure with no hollow interiors. In such embodiments, VSP vortex stabilizer may be constructed out of metal, a metal alloy, refractory, a ceramic, and/or a ceramet. In other embodiments, VSP vortex stabilizer 250 may comprise a shell 251 defining a hollow interior.

In certain embodiments, shell 251 may be constructed out of steel, stelitem refractory, ceramics, and/or ceramets. In certain embodiments, shell 251 may have a thickness in the range of from 0.01 meters to 0.025 meters at second side surface 254 and a thickness in the range of from 0.0075 inches to 0.025 inches at top surface 252.

In certain embodiments, VSP stabilizer 250 may comprise top surface 252, first side surface 253, second side surface 254, and bottom 255.

In certain embodiments, top surface 252 may be a flat circular shaped surface. In certain embodiments, top surface 252 may comprise a uniform diameter. In certain embodiments, the diameter of top surface 252 may be sized based upon its application. In certain embodiments the diameter of top surface 252 may be in the range of from 0 meters to 0.5 meters. In certain embodiments the diameter of top surface 252 may be in the range of from 0.05 meters to 0.5 meters. In other embodiments, the diameter of top surface 252 may be in the range of from 0.2 meters to 0.4 meters. In certain embodiments, top surface 252 may be a smooth, polished surface. In certain embodiments, not illustrated in FIG. 2, an S-Pin may be attached to top surface 252. In certain embodiments, the S-Pin may have the same geometry and material make up of any vortex extender pin described in U.S. Pat. No. 7,648,544.

In certain embodiments, first side surface 253 may be cylindrically shaped with a height in the range of from about 0.006 meters to about 0.05 meters. In certain embodiments, the diameter of first side surface 253 may be the same as the diameter of top surface 252.

In certain embodiments, second side surface 254 may be cylindrically shaped with a taper. In certain embodiments, the taper may be a uniform taper. In certain embodiments, the taper of second side surface 254 may be in the range of 10 degrees to about 60 degrees. In other embodiments, the taper of second side surface 254 may be in the range of from about 20 degrees to about 50 degrees. In certain embodiments, the taper of second side surface 254 may be in the range of from 30 degrees to 40 degrees. In other embodiments, the taper may be a non-uniform taper.

In certain embodiments, the diameter of side surface 254 may increase from an initial diameter to a final diameter. In certain embodiments, the initial diameter of second side surface 254 may be equal to the diameter of first side surface 253.

In certain embodiments, the final diameter of second side surface 254 may be sized based upon its application. In certain embodiments, the ratio of the final diameter of second side surface 254 to the initial diameter of second side surface 254 may be in the range of from be in the range of from 1.5:1 to 5:1. In certain embodiments, the ratio of the final diameter of second side surface 254 to the initial diameter of second side surface 254 may be in the range of from be in the range of from 2:1 to 4:1. In certain embodiments, the ratio of the final diameter of second side surface 254 to the initial diameter of second side surface 254 may be greater than 5:1, in the range of from 5:1 to 10:1, in the range of from 10:1 to 50:1, or greater than 50:1.

In certain embodiments, the diameter of side surface 254 may increase from an initial diameter to a final diameter uniformly. In other embodiments, the diameter of side surface 254 may increase from an initial diameter to a final diameter non-uniformly. In certain embodiments, the height of side surface may be in the range of from 0.1 meters to 0.25 meters.

In certain embodiments, bottom 255 may have a diameter equal to the final diameter of second side surface 254. In certain embodiments, bottom 255 may be an open bottom. In certain embodiments, an open bottom design of VSP vortex stabilizer 250 may be desirable as it permits a reduction in the total weight of VSP vortex stabilizer 250 and reduces vibrations and bending moments acting upon VSP vortex stabilizer 250.

Referring back to FIG. 1, vortex stabilizer 150 may comprise any combination of features discussed above with respect to VSP vortex stabilizer 250. In certain embodiments, vortex stabilizer 150 may comprise shell 151, top surface 152, first side surface 153, second side surface 154, and bottom 155

In certain embodiments, the dimensions of vortex stabilizer 150 may vary based upon the dimensions of tubular housing 110. In certain embodiments, the ratio of the diameter of top surface 152 to the inner diameter of tubular housing 110 may be in the range of from 0.05:1 to 0.7:1. In certain embodiments, the ratio of the diameter of top surface 152 to the inner diameter of tubular housing 110 may be in the range of from 0.1:1 to 0.5:1. In certain embodiments, the ratio of the diameter of top surface 152 to the inner diameter of tubular housing 110 may be in the range of from 0.2:1 to 0.3:1. In certain embodiments, the ratio of the final diameter of second side surface 154 to the inner diameter of tubular housing 110 may be in the range of from 0.5:1 to 2:1. In certain embodiments, the ratio of the final diameter of second side surface 154 to the inner diameter of tubular housing 110 may be in the range of from 0.75:1 to 1.5:1. In certain embodiments, the ratio of the final diameter of second side surface 154 to the inner diameter of tubular housing 110 may be in the range of from 1:1 to 1.25:1.

In certain embodiments, vortex stabilizer 150 may be disposed centrally below tubular housing 110. In certain embodiments, a portion of vortex stabilizer 150 may extend into hollow interior 112. In certain embodiments, vortex stabilizer 150 may positioned such that top surface 152 even with bottom opening 114. In other embodiments, vortex stabilizer 150 may be positioned such that top surface 152 is above bottom opening 114. In certain embodiments, vortex stabilizer 150 may be held in place by two or more mounting brackets 160. In certain embodiments, mounting brackets 160 may be welded to outer housing 110 and vortex stabilizer 150.

In certain embodiments, vortex stabilizer 150 may act to stabilize a cyclone within hollow chamber 112 when separation swirl tube 100 is in operation. As used herein the term “stabilize” may refer to locating and maintaining the vortex centerline in the middle of the swirl tube 112 and setting up pressure conditions to regulate the gas-solids flow in 112.

In certain embodiments, swirl tube separator 100 may suitably be used for various types of gas-solid separations. In certain embodiments, swirl tube separator 100 may be used to separate solids having a diameter ranging between 1×10⁻⁶ m and 250×10⁻⁶ m from a gas stream. In certain embodiments, the gas stream may have a solids content of between 10 and 12,000 mg/Nm³. In certain embodiments, the cleaned gas leaving swirl tube separator 100 can have emission levels of below 50 mg/Nm³, below 30 mg/Nm³, or below 10 mg/Nm³. In certain embodiments, swirl tube separator 100 may operate at a separation efficiency of from 90% to near 100%.

Referring now to FIG. 3, FIG. 3 illustrates a third stage separator 1000 in accordance with certain embodiments of the present disclosure. As can be seen in FIG. 3, third stage separator 1000 may comprise: a pressure vessel 1100, a plurality of swirl tube separators 1200, flue gas/catalyst fine inlet 1300, flue gas outlet 1400, and underflow gas/catalyst fine outlet 1500.

In certain embodiments, third stage separator 1000 may comprise between 1 and 500 swirl tube separators 1200 disposed within pressure vessel 1100. In certain embodiments, third stage separator 1000 may comprise between 70 and 150 swirl tube separators 1200 disposed within pressure vessel 1100. FIG. 3 illustrates a third stage separator 1000 comprising 4 swirl tube separators 1200.

In certain embodiments, swirl tube separators 1200 may comprise any combination of features discussed above with respect to swirl tube separator 100. In certain embodiments, the plurality of swirl tube separators 1200 may be positioned within pressure vessel 1100 such that a flue gas and catalyst mixture entering pressure vessel 1100 through flue gas/catalyst fine inlet 1300 may pass into swirl tube separator 1200. In certain embodiments, the plurality of swirl tube separators 1200 may be positioned within pressure vessel 1100 such that flue gas may exit swirl tube separator and then exit pressure vessel 1100 through flue gas outlet 1400. In certain embodiments, the plurality of swirl tube separators 1200 may be positioned within pressure vessel 1100 such that catalyst fines may exit swirl tube separator and then exit pressure vessel 1100 through underflow gas/catalyst fine outlet 1500.

In certain embodiments, the present disclosure provides a method comprising: providing a third stage separator, wherein the third stage separator comprises a pressure vessel, a flue gas/catalyst fine inlet, a flue gas outlet, an underflow gas/catalyst fine outlet, and a swirl tube separator, wherein the swirl tube separator comprises a tubular housing, a gas-solids inlet opening, a gas outlet conduit, a vane, and VSP vortex stabilizer; and introducing a gas stream into the third stage separator.

In certain embodiments, the third stage separator may comprise any third stage separator discussed above. In certain embodiments, the gas stream may comprise any gas stream that contains solids. In certain embodiments, the gas stream may comprise flue gas catalyst mixture may comprise solids having diameters ranging between 1×10⁻⁶ m and 250×10⁻⁶ m from a gas stream. In certain embodiments, the gas stream may have a solids content of between 10 and 12,000 mg/Nm³.

In certain embodiments, the method may further comprise removing solids from the gas stream. In certain embodiments, solids may be removed from the gas stream by allowing the gas stream to enter into the swirl tube separator. In certain embodiments, removing solids from the gas stream may comprise generating a cleaned gas stream. In certain embodiments, the cleaned gas stream may have a solids content of below 50 mg/Nm³, below 30 mg/Nm³, or even below 10 mg/Nm³.

To facilitate a better understanding of the present invention, the following examples of specific embodiments are given. In no way should the following examples be read to limit, or to define, the scope of the invention.

### EXAMPLES

### Example 1

Computer simulations were conducted to test the separation efficiency of a third stage separator system comprising two separation swirl tubes in various configurations. In the first configuration, the two separation swirl tubes did not comprise any vortex stabilizers. In the second configuration, the two separation swirl tubes comprised S-Pin vortex stabilizers. In the third configuration, the two separation swirl tubes comprised VSP vortex stabilizers in accordance with certain embodiments of the present disclosure.

For each of the configurations, a simulation was done introducing catalyst fines into a dual swirl tube system. The geometry and flowrates were representative of typical TSS swirl tube operations. Solids loading to the swirl tubes was varied in the range of 120 mg/Nm³ up to 12,000 mg/Nm³ with the total gas flowrate, pressure and temperature held constant.

Simulations measured the separation efficiency, swirl tube pressure drop, and velocity magnitude of both gas and solids flow of the swirl tube as a function of both solids loading and termination device.

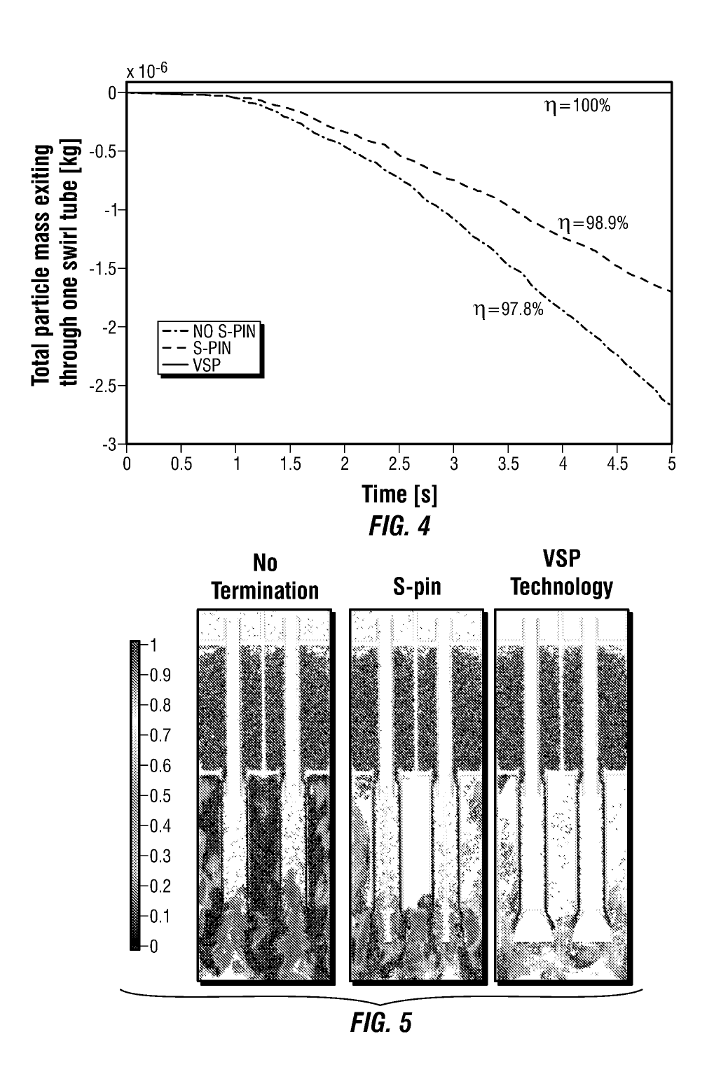

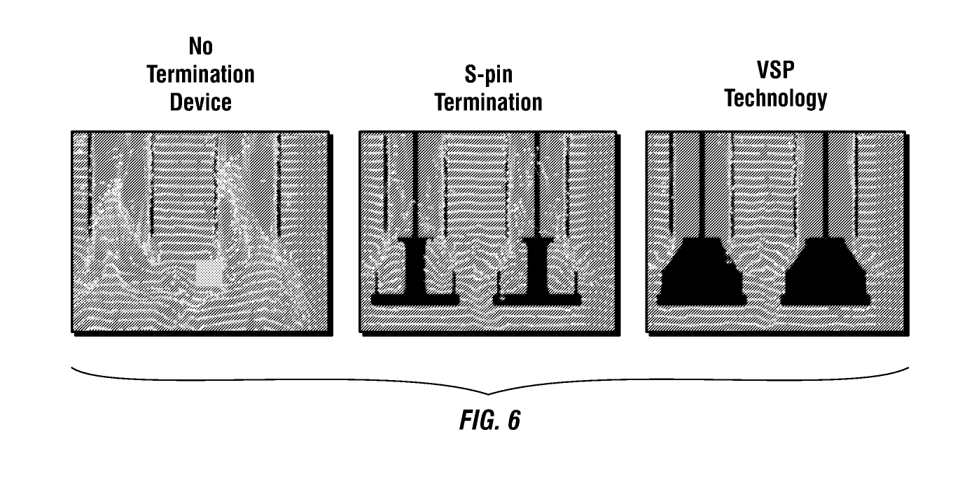

A chart depicting the separation efficiencies for each configuration is shown in FIG. 4. An illustration of the cross-talk for each configuration is shown in FIG. 5. An illustration of the particle vectors for each configuration is shown in FIG. 6.

Referring to FIG. 4, FIG. 4 illustrates that the overall separation efficiency for the third configuration was much higher than the overall separation efficiency of the first and second configurations. The separation efficiency was measured to be 100% for the third configuration and was only measured to be 97.8% for the second configuration and 98.9% for the first configuration.

Referring now to FIG. 5, FIG. 5 shows that while cross talk of particles between each of the swirl tube separators occurred in the first and second configurations, no cross talk of particles between each of the swirl tube separators occurred in the third configuration. This indicates that the third configuration was the most efficient.

Referring now to FIG. 6, FIG. 6 shows the instantaneous particle vectors at a swirl tube cross-section. The vectors show the movement of the catalyst particles in the swirl tube. With the S-pin and without S-pin the swirl tube shows that particles are entrained into the center of the swirl tube and then travel up to the gas outlet tube. With a VSP vortex stabilizer in place, FIG. 6 shows that the particles are confined to the walls of the swirl tube and do not get pulled into the central vortex.

Thus, the results show that the swirl tube separators disclosed herein perform at a higher level than conventional swirl tube separators.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A separation swirl tube comprising: a tubular housing, a gas-solids inlet opening, a gas outlet conduit, a vane, and a VSP vortex stabilizer.

2. The separation swirl tube of claim 1, wherein the VSP vortex stabilizer comprises a solid structure with no hollow interior.

3. The separation swirl tube of claim 1, wherein the VSP vortex stabilizer comprises a shell defining a hollow interior.

4. The separation swirl tube of claim 1, wherein the VSP vortex stabilizer comprise a top surface, a first side surface, a second side surface, and a bottom.

5. The separation swirl tube of claim 4, wherein the top surface has a diameter in the range of from 0.05 meters to 0.5 meters.

6. The separation swirl tube of any claim 4, wherein the second side surface has an initial diameter and a final diameter.

7. The separation swirl tube of claim 6, wherein the initial diameter of the second side surface is equal to the diameter of the top surface.

8. The separation swirl tube of claim 6, wherein the ratio of the final diameter of the second side surface to the initial diameter of the second side surface is in the range of from 1.5:1 to 5:1.

9. The separation swirl tube of claim 1, wherein the tubular housing has an inner diameter in the range of from 0.15 meters to 1.5 meters.

10. The separation swirl tube of claim 1, wherein the VSP vortex stabilizer is disposed centrally below the tubular housing.

11. The separation swirl tube of claim 1, wherein a portion of VSP vortex stabilizer extends into a hollow interior defined by the tubular housing.

12. The separation swirl tube of claim 1, wherein the VSP vortex stabilizer is attached to the tubular housing by one or more mounting brackets.

13. A third stage separator comprising: a pressure vessel, a flue gas/catalyst fine inlet, a flue gas outlet, an underflow gas/catalyst fine outlet, and a swirl tube separator, wherein the swirl tube separator comprises a tubular housing, a gas-solids inlet opening, a gas outlet conduit, a vane, and VSP vortex stabilizer.

14. The third stage separator of claim 13, wherein the VSP vortex stabilizer comprises a solid structure with no hollow interior.

15. The third stage separator of claim 13, wherein the VSP vortex stabilizer comprises a shell defining a hollow interior.

16. The third stage separator of claim 13, wherein the VSP vortex stabilizer comprise a top surface, a first side surface, a second side surface, and a bottom.

17. The third stage separator of claim 13, wherein the VSP vortex stabilizer is disposed centrally below the tubular housing.

18. The third stage separator of claim 13, wherein a portion of VSP vortex stabilizer extends into a hollow interior defined by the tubular housing.

19. A method comprising:
providing a third stage separator, wherein the third stage separator comprises a pressure vessel, a flue gas/catalyst fine inlet, a flue gas outlet, an underflow gas/catalyst fine outlet, and a swirl tube separator, wherein the swirl tube separator comprises a tubular housing, a gas-solids inlet opening, a gas outlet conduit, a vane, and VSP vortex stabilizer; and
introducing a gas stream into the third stage separator.

20. The method of claim 19, further comprising removing solids from the gas stream.
